(19) United States
(12) Patent Application Publication
(10) Pub. No.: US 2004/0238056 A1
(43) Pub. Date: Dec. 2, 2004

(54) Cooler drain having polypropylene inner drain and thermoplastic elastomer outer drain

(76) Inventors: Ray Young, Latham, KS (US); David Price, Arkansas City, KS (US); Elena Sapatova, Copley, OH (US); Jim McQuown, Wooster, OH (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/447,192

(22) Filed: May 28, 2003

(51) Int. Cl. F16L 55/10

(52) U.S. Cl. 138/89

(57) ABSTRACT

An insulated container includes a drain assembly having an outer drain and an inner drain. The inner drain may be constructed from a polypropylene material and the outer drain may be constructed from a thermoplastic elastomer material, in order to provide a higher quality seal, a snap-on assembly method, and a dual material ergonomic feel to the user.

### BACKGROUND OF THE INVENTION

The present invention relates to drain assemblies for insulated containers, such as insulated containers for holding liquids and insulated containers for holding items such as food products and/or beverages and maintaining the items at a low temperature.

Typically, an insulated container includes a drain assembly that may be used to dispense a beverage or to drain water accumulated in the container when ice melts therein. Many insulated containers utilize a polypropylene material for an outer drain and also for an inner drain which can present difficulty of consumer use when a polypropylene outer drain plug binds inside of an inner drain also constructed from polypropylene. Furthermore, in assembling drain parts for insulated containers, typically a manual assembly method using a torque wrench and fixture is utilized. In addition, due to the relatively high durometer of the polypropylene material used, a low quality seal is sometimes attained between the drain plug and the outer drain.

### SUMMARY OF THE INVENTION

In accordance with one aspect of the invention, an insulated container includes a drain assembly having an inner drain and an outer drain. The inner drain may be constructed from a polypropylene material.

In accordance with another aspect of the invention, an outer drain may be constructed from a thermoplastic elastomer material and may be mated to an inner drain constructed from a polypropylene material. Due to the relatively soft durometer of the thermoplastic elastomer material of the outer drain, the outer drain does not bind with the drain plug. By using an elastomer for the outer drain, a “snap-on” assembly method may be used and a higher quality seal may be achieved. An additional benefit of the material changed to a thermoplastic elastomer is that it gives the outer drain a dual material ergonomic feel to the user.

### BRIEF DESCRIPTION OF THE DRAWINGS

Objects, features, and advantages of the present invention will become apparent upon reading the following description in conjunction with the drawing figures, in which:

FIG. 1 is a perspective view of an insulated container including a drain assembly according to the invention; and

FIG. 2 is a cross-sectional view, taken along lines 2-2 of FIG. 1, showing the drain assembly of the insulated container.

### DETAILED DESCRIPTION OF THE INVENTION

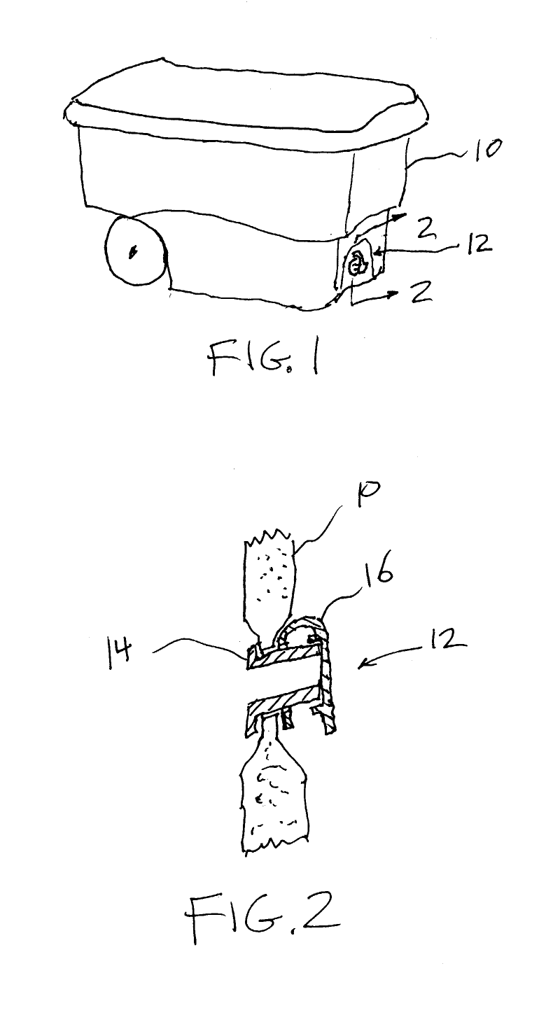

With reference initially to FIG. 1, an insulated container 10 includes a drain assembly, generally depicted at 12. The drain assembly may be used to dispense liquids from the insulated container, and/or to drain excess water from ice that has melted within the insulated container.

The drain assembly 12 includes an inner drain 14 and an outer drain 16. In order to provide a leak-proof seal between the outer drain 16 and the inner drain 14, the outer drain 16 may be constructed from a thermoplastic elastomer material and the inner drain 14 may be constructed from a polypropylene material.

Because the outer drain 16 may be constructed from thermoplastic elastomer material, the outer drain may be attached to the insulated container using a “snap-on” assembly method. The use of a thermoplastic elastomer material for the outer drain 16 also provides a higher quality seal and a dual material ergonomic feel to the user.

Although a particular example of a drain assembly has been disclosed and described herein in accordance with the teachings of the present invention, the scope of coverage of this patent is not limited thereto. On the contrary, this patent covers all embodiments of the teachings of the invention that fairly fall within the scope of permissible equivalents.

We claim:

1. A drain assembly for an insulated container comprising:
an inner drain; and
an outer drain, wherein the outer drain is constructed from thermoplastic elastomer material.

2. The drain assembly of claim 1, wherein the inner drain is constructed from a polypropylene material.

3. An insulated container comprising:
an inner drain; and
an outer drain, wherein the outer drain is constructed from a thermoplastic elastomer material.

4. The insulated container of claim 3, wherein the inner drain is constructed from a polypropylene material.
